(19) United States
(12) Patent Application Publication
(10) Pub. No.: US 2016/0074139 A1
(43) Pub. Date: Mar. 17, 2016

(54) Indirect Bonding Tray and Method of Manufacture Thereof

(71) Applicant: American Orthodontics Corporation, Sheboygan, WI (US)

(72) Inventors: William Charles Machata, Kohler, WI (US); Michael Craig Marshall, Sheboygan Falls, WI (US)

(73) Assignee: American Orthodontics Corporation, Sheboygan, WI (US)

(21) Appl. No.: 14/949,132

(22) Filed: Nov. 23, 2015

Related U.S. Application Data
(63) Continuation-in-part of application No. 14/199,343, filed on Mar. 6, 2014.
(60) Provisional application No. 62/214,641, filed on Sep. 4, 2015.

(51) Int. Cl. A61C 7/14

(52) U.S. Cl. CPC A61C 7/146

(57) ABSTRACT

An indirect bonding tray includes a least one tooth portion. Each tooth portion includes an occlusal surface that conforms to an occlusal surface of an associated tooth of a patient's dentition. At least one arm includes an arm tip configured to engage an orthodontic bracket. The at least one arm is movably attached to at least one tooth portion to move between a first position and second position relative to a bonding surface of the associated tooth. In the second position, the arm is in a position configured to hold an orthodontic bracket in a predetermined treatment position relative to the bonding surface of the associated tooth.

### CROSS-REFERENCE TO RELATED APPLICATION

The present application is a Continuation-in-Part of U.S. patent application Ser. No. 14/199,343, filed on Mar. 6, 2014, which published as US 2014-0255864 on Sep. 11, 2014, the contents of which is hereby incorporated herein by reference in its entirety. The present application also claims priority of U.S. Provisional Patent Application No. 62/214,641, filed on Sep. 4, 2015, the content of which is hereby incorporated herein by reference in its entirety.

### BACKGROUND

The present disclosure relates to the field of orthodontics. More specifically, the present disclosure relates to a tray for use in an indirect bonding method of orthodontic bracket application, and a method of manufacturing such a tray.

Orthodontic brackets can be bonded to a patient's teeth by an orthodontist either through a direct method in which the orthodontist manually bonds each bracket one at a time to each of the patient's teeth or through an indirect method in which a bonding tray holds and seats multiple brackets to the patient's teeth. While the indirect bonding technique offers some alignment verification through the use of the tray, bracket placement through either manual or indirect bonding techniques is determined by experience and skill of the orthodontist. Incorrect bracket placement often leads to unintended arch wire bending or the need for bracket repositioning during treatment. These intra-treatment procedures are time consuming clinically and can lead to prolonged treatment times.

Available indirect bonding trays also generally limit access to bracket pads during the bonding process which can present challenges for orthodontists to create clean and reliable bonds on all of the brackets applied to a patient's teeth.

### BRIEF DISCLOSURE

An exemplary embodiment of an indirect bonding tray may be used in positioning of a plurality of orthodontic appliances. The indirect bonding tray includes a tray which includes an occlusal surface which is adapted to conform to occlusal surfaces of associated teeth of a patient's dentition. The tray includes a plurality of apertures which extend at least partially through the tray. A plurality of arms each include a slide portion and a tip. The tip is adapted to releaseably engage an orthodontic appliance of the plurality of orthodontic appliances. Each slide portion of the plurality of arms movably engages an aperture of the plurality of apertures. The apertures are individually oriented such that movement of the slide portions of each of the plurality of arms relative to the apertures of the plurality of apertures moves the arms between a first position and a second position relative to the tray. In the first position, the tip of each arm of the plurality of arms is in a position away from the tray. In the second positions, each arm of the plurality of arms is in a position to hold an orthodontic appliance of the plurality of orthodontic appliances in a predetermined treatment position relative to a bonding surface of an associated tooth.

In an exemplary embodiment of an indirect bonding tray system, a first tooth portion includes an occlusal surface that conforms to an occlusal surface of a first specific tooth of a patient's dentition. The first tooth portion includes a first tray body that extends in a gingival-occlusal dimension between the occlusal surface and an exterior surface. The first tray body includes a first aperture. The indirect bonding tray system further includes a first orthodontic appliance. A first arm of the indirect bonding tray system includes a first arm tip. The first arm tip engages the first orthodontic appliance. The first arm is movably engaged to the first aperture of the first tooth portion. The first arm moves between a first position and a second position within the first aperture. The first aperture is digitally designed relative to a predetermined placement for the first orthodontic appliance on the first specific tooth such that the first aperture is dimensioned to hold the first arm and first orthodontic appliance in the predetermined placement relative to a bonding surface of the first specific tooth when the first arm is in the second position.

An exemplary embodiment of an indirect bonding tray includes a tray body. The tray body includes an exterior surface and an occlusal surface generally opposed to the exterior surface. The occlusal surface is configured to conform to occlusal surfaces of associated teeth of a patient's dentition. A plurality of apertures are formed into the tray body. Each aperture of the plurality of apertures is located at a position in the tray body associated with a particular tooth of the patient's dentition. Each aperture of the plurality of apertures is digitally designed and individually dimensioned to receive an arm carrying an orthodontic appliance such that movement of the arm within the aperture guides the orthodontic appliance to a predetermined placement of the orthodontic appliance on the particular tooth of the patient's dentition.

### BRIEF DESCRIPTION OF THE DRAWINGS

FIG. 1 is a cross-sectional view of an embodiment of an indirect bonding tray with a pivoting arm.

FIG. 2 is a cross-sectional view of an embodiment of an indirect bonding tray with a sliding arm.

FIG. 3 is a cross-sectional view of an alternative embodiment of an indirect bonding tray with a sliding arm.

FIG. 4 is a side view depicting an exemplary embodiment of an arm for use with an indirect bonding tray.

FIG. 5 is a top view depicting an embodiment of a segmented indirect bonding tray.

FIG. 6 depicts an exemplary embodiment of an arm.

FIG. 7 depicts and exemplary embodiment of a bracket connected to the arm of FIG. 6.

FIG. 8 is a flow chart that depicts an embodiment of a method of fabricating an indirect bonding tray.

FIG. 9 is a flow chart that depicts a further method using an indirect bonding tray to construct customized composite bases to individualize brackets to a patient.

FIGS. 10A-E depict various views of another exemplary embodiment of an indirect bonding tray.

FIGS. 11A-C depict various close-up views of portions the indirect bonding tray depicted in FIGS. 10A-E.

FIG. 12 depicts an additional exemplary embodiment of a tray.

FIG. 13A depicts a close up view of an exemplary embodiment of an indirect bonding tray with connectors between tray portions.

FIG. 13 B depicts a sectional view of an exemplary embodiment of an indirect bonding tray of FIG. 13 A.

FIG. 14 depicts a further exemplary embodiment of an indirect bonding tray.

FIG. 15 exemplarily depicts an arch wire plane digitally positioned on a post-treatment model of a patient's dentition.

### DETAILED DISCLOSURE

Indirect bonding trays as disclosed herein and the methods of manufacturing such trays can be used by dental professionals to precisely place orthodontic brackets and/or create customized composite bases for orthodontic brackets placed in a direct or indirect manner. Embodiments as disclosed herein are understood to be given as examples and a person of ordinary skill in the art can carry out concepts as disclosed herein in other manners and combinations apart from the specific exemplary embodiments disclosed. Some embodiments may be carried out without all specific features described therein while individual characteristics of two or more embodiments may be combined to result in further embodiments within the scope of the present disclosure.

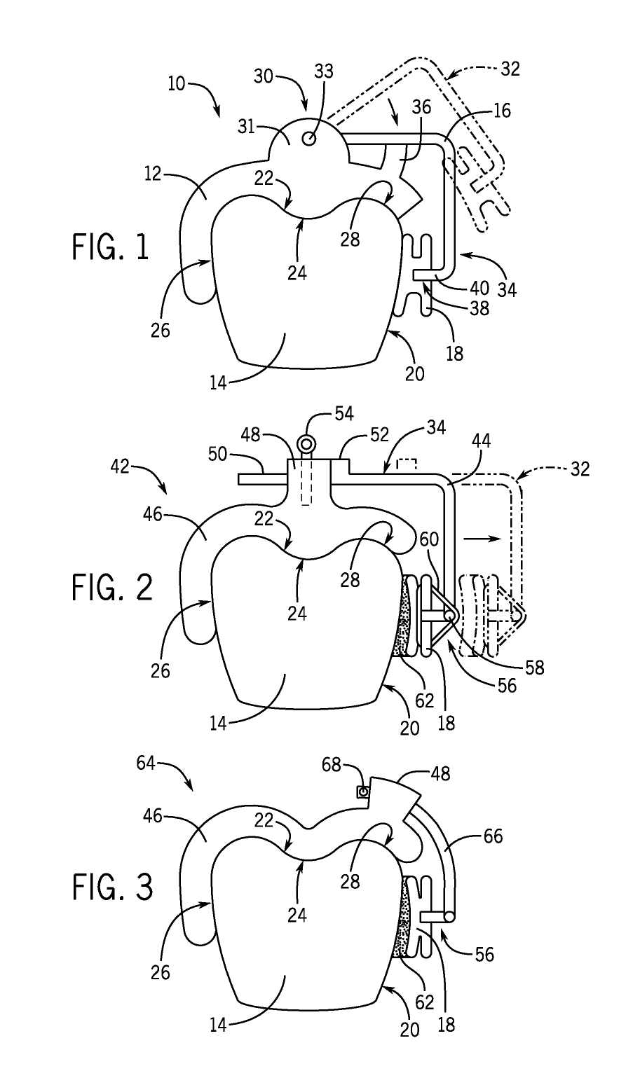

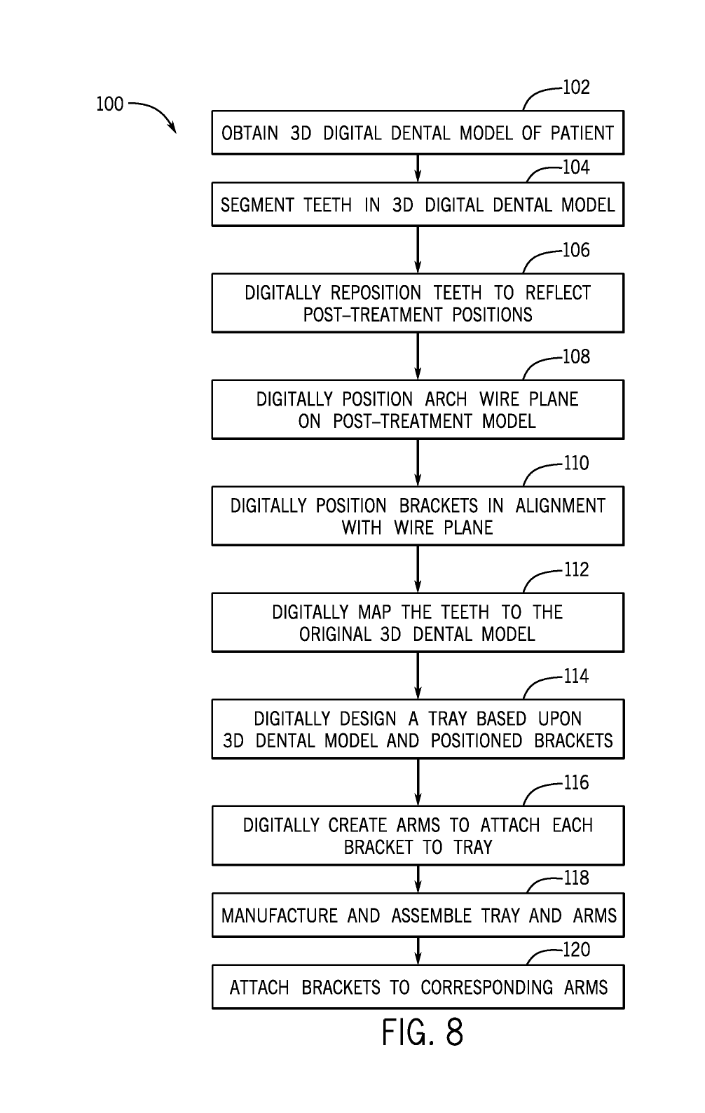

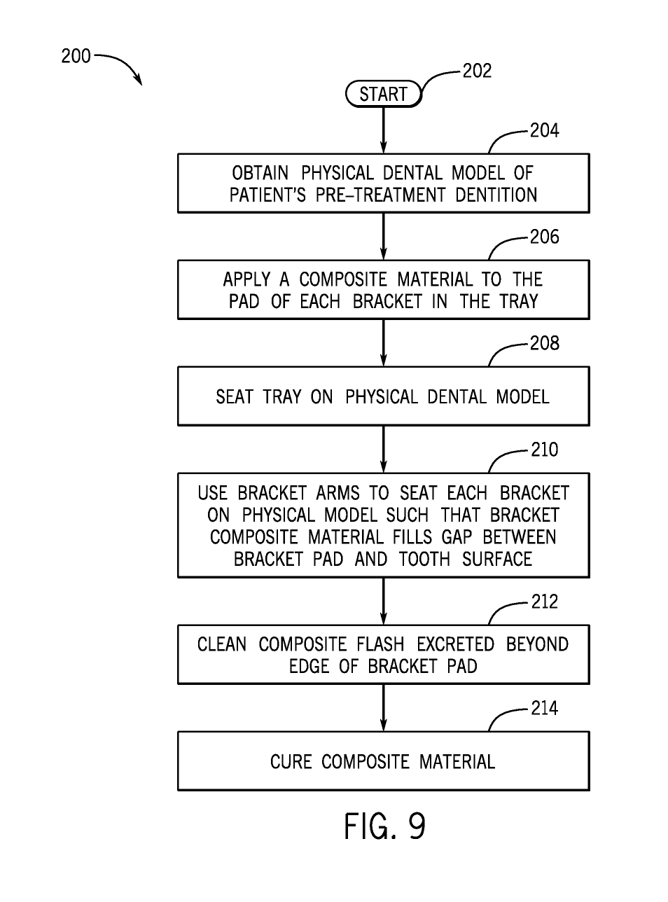

FIGS. 1-7 and 10-14, as will be described in greater detail herein, present various embodiments of indirect bonding trays which in some embodiments may be constructed according to the method 100 as disclosed herein with respect to FIG. 8. Still further embodiments of indirect bonding trays may be used in accordance with the method 200 of using an indirect bonding tray to construct customized composite bases, such method depicted in the flow chart of FIG. 9.

FIG. 8 is a flow chart that depicts an embodiment of a method 100 of manufacturing an indirect bonding tray. At 102 a three-dimensional digital model of the patient's pre-treatment dentition is obtained. This 3D digital model may be obtained in a variety of ways including, but not limited to medical imaging techniques such as computed tomography (CT), by creating a plaster cast of the patient's dentition and digitally scanning the cast, or by intraoral scanning.

At 104 the 3-D digital model is manipulated to segment the individual teeth within the 3-D digital model. The separated teeth are digitally repositioned at 106 to reflect the desired post-treatment positions of the patient's teeth. Each of the transformations required to digitally reposition the separated teeth are recorded and saved. This creates both a record of the original pre-treatment dentition and the transformation required by treatment. Once the teeth have been repositioned into the post-treatment positions, then at 108 an arch wire plane is positioned on the post-treatment model created at 106. FIG. 15 exemplarily depicts an arch wire plane P positioned on an exemplary digital model M of a patient's post-treatment dentition. It is to be noted that in embodiments, the arch wire plane may be curved, exemplarily to reflect curve of Spee, curve of Wilson, or other dentition.

At 110 digital models of brackets and/or tubes are digitally positioned on each of the patient's teeth in alignment with the arch wire plane. It will be recognized that unless otherwise specified, the structures of brackets and tubes may be understood to interchangeably reference orthodontic apparatus secured to or configured to be secured to the dentition of the patient. The brackets and/or tubes are positioned such that a slot in each bracket and/or tube coincides with the arch wire plane and the bracket touches or nearly touches the appropriate surfaces of the teeth in the post-treatment model. Once the individual relationship between each of the brackets and the teeth in the post-treatment model has been established, at 112 the positioned brackets are mapped back to the original 3-D digital model of the patient's pre-treatment dentition. This mapping may be carried out by reversing each of the previously recorded and stored transformations to digitally reposition the teeth. In an embodiment as described in further detail herein, the mapping 112 may include mapping the individual teeth along with a portion of the arch wire plane (as located at 108) associated with each tooth.

At 114 a bonding tray is digitally designed around the 3-D digital model of the patient's dentition and the positioned brackets. The tray may be any of the trays as disclosed in further detail herein, and is designed to conform to the appropriate tooth surfaces such that the tray conforms to the dentition while not interfering with the placement of the brackets on the patient's teeth. Exemplarily, the tray may be designed to conform to the occlusal tooth surface. It will be recognized that in embodiments, when the tray conforms to the dentition of the patient, the tray may not engage occlusal surfaces of some teeth due to the position and/or orientation of specific teeth in the patient's pre-treatment dentition. For example, the tray may bridge across a tooth in the patient's dentition without engaging that tooth at all. This may exemplarily occur if a tooth in the pre-treatment dentition is inaccessible due to excessive crowding or exhibits excessive labial or lingual eruption. In embodiments, an arm and aperture associated with the crowded tooth may still be incorporated into the tray to facilitate bracket placement thereon. In other embodiments, the orthodontist may secure a bracket to the tooth intra-treatment, as crowing in relieved.

In embodiments, the tray may further be designed to engage at least a portion of a tooth surface that is opposed to the surface upon which the bracket will be placed. For example, if the brackets are placed on the labial tooth surface, then the tray may be designed to further conform to at least a portion of the opposite lingual tooth surfaces. On the other hand, if the brackets are to be placed lingually, then the tray may be designed to conform to at least a portion of the labial tooth surfaces. It is to be recognized that in further embodiments, a combination of bracket placement and conformation to tooth surfaces of the tray may occur on the same tooth surface in a single tray. Exemplarily a tray may conform to at least a portion of the labial surface of one or more teeth while the tray is also configured as disclosed herein to place a bracket on the labial surface of the same tooth. In a further exemplary embodiment, single tray may be configured for placement of some brackets on labial surfaces of the teeth and other brackets on lingual surfaces of the teeth.

The digital design of the tray may be performed automatedly with the application of standard tray dimensions relative to the 3-D digital model of the patient's dentition. Alternatively, a technician may input one or more boundaries or parameters for the design of the tray or select from one or more basic tray templates and the additional features of the tray can be added automatedly based upon the 3-D digital model and the bracket placements. In an embodiment, the tray may be generally digitally formed by digitally subtracting volume of the teeth from the standardized volume of the standard tray dimensions. In some embodiments, at least a portion of an exterior or occlusal portion of the tray is defined relative to the patient's dentition. In one embodiment, the bonding tray is designed by defining a tray thickness that is consistent across at least portions of the tray. This thickness is extended outwardly from the tooth surfaces of the digital model of the patient's pre-treatment dentition at directions perpendicular to the tooth surface. In one embodiment, the tray thickness is the same thickness as the pads digitally placed on the digital model, while in alternative embodiments, the tray thickness may be greater than or less than the pad thickness. A tray thickness for some or all portions of a tray may be of a sufficient thickness to accommodate one or more of the various connections between the arms and the tray as disclosed herein. In still further embodiments, the tray may extend generally at a predetermined thickness above the occlusal plane of the pre-treatment dentition. As further described herein, portions of the tray may be thicker than others such as to accommodate apertures for respective arms as described in further detail herein.

At 116 arms are digitally created to movably attach each bracket to the tray. The arms may exemplarily be any of the arms as described in embodiments in further detail herein. The arms are designed to move with respect to the tray to place the bracket at the digitally located bracket position. The design of the arms may be performed automatedly by applying predefined algorithms or design relationships that define the size, shape, and/or dimensions of the arms to the digitally created tray and the bracket placements. The arm design may be done automatedly or upon a technician selection of a particular arm design or configuration. The arms are designed with relationship to the position of the bracket on the tooth and the portion of the tray designed to conform with that tooth. Embodiments of the arms may be designed with arm tips that are dimensioned as described with respect to embodiments disclosed herein to fit an arch wire slot or another physical feature of a corresponding bracket. The arm tip may be dimensioned to provide a friction fit with the bracket or another physical feature of the bracket. In still further embodiments described herein, the arm tip is designed to releasably and/or resiliently hold or pinch the bracket. A same or similar arm tip may be designed to releasably and/or resiliently hold or pinch a tube. Additionally, the arm design and/or arm tip design cooperates with the physical features of the bracket to position the bracket at the predetermined torque, tilt, or rotation relative to the tooth.

In am exemplary embodiment, when the teeth are mapped back to their pre-treatment positions at 112, the individual teeth are mapped along with a portion of the arch wire plane associated with each tooth. In embodiments, the tray is designed with apertures as described in further detail herein adapted to direct the arm associated with that aperture to maintain the arch wire slot of a bracket affixed to the arm aligned on the portion of the arch wire plane as the arm moves from the first position to the second position.

At least one wall, and in other embodiments a combination of walls, of each of the apertures defines the path an arm translating within the aperture. The path of the arm defined by the aperture maintains the arch wire slot of a bracket secured to the arm in alignment with the portion of the arch wire plane of the tooth upon which the bracket is to be secured.

When in use, embodiments that translate the bracket secured to the arm in a manner that maintains the arch wire slot of the bracket in alignment with arch wire plane assigned to that tooth provide additional advantages. The embodiments establish and maintain the predetermined orientation between the bracket pad and the bonding surface while the arm carrying the bracket is translated relative to the tray. Accuracy is improved in achieving bracket placement at the predetermined position as the ad is maintained parallel to the bonding surface throughout the translation. This minimizes error over embodiments that pivot the bracket as undershoot of overshoot may further change the angle of the bracket as mounted to the bonding surface. This also minimizes error from undershoot or overshoot because relation to the arch wire plane is maintained.

At 118 the digitally designed tray and arms are manufactured. The manufacture of such a digitally designed tray and arms may be done exemplarily using rapid prototyping, 3D printing, or CNC milling techniques. In such embodiments, the tray may be constructed such as to be releasably secured to the patient's dentition by a friction fit between the teeth and the tray while in an alternative embodiment an adhesive or the like may be applied to the interior of the tray to facilitate temporarily securing the guide tray to the patient's teeth. However, it is understood that other manufacturing techniques may be used. In embodiments in which the tray and arms are not manufactured in a pre-assembled form, the trays and arms may be separately manufactured and then assembled. In an embodiment, the arms may be of a standardized design and thus may be mass-produced for example by injection molding, and the tray is designed to accommodate the arms in positions to properly place the brackets. In some embodiments, it is recognized that the arms may be movably fixed to the tray. While in other embodiments, the arms may be removable from connection with the tray. At 120 the brackets to be bonded to the patient's teeth are attached to the corresponding arms.

Referring to FIG. 1, FIG. 1 depicts a cross sectional view of an exemplary embodiment of an indirect bonding tray 10 as may be constructed in accordance with the method disclosed herein. The indirect bonding tray 10 includes a tray 12 that is designed to conform to a patient's tooth 14 and an arm 16 that is configured to movably position an orthodontic bracket 18 with respect to a bonding surface 20 of the tooth 14. It will be recognized that similar embodiments are configured for placement of a buccal tube (not depicted) on a tooth. It will be recognized that in embodiments, the indirect bonding tray 10 is configured to assist in the placement of a plurality of brackets and/or tubes to a plurality of teeth in a patient's dentition.

As described above, the tray 12 is designed to conform to one or more surfaces of the tooth. Namely, the tray 12 includes an occlusal surface 22 to conform to an occlusal surface 24 of the tooth 14. The tray 12 can also include a second surface 26 that is configured to conform to one of the tooth sides, namely a lingual side or a labial side of the tooth 14. It is to be recognized that the tooth 14 depicted in FIG. 1 is generically depicted such that either side of the tooth may represent the lingual or labial side. In still further embodiments, the tray 12 may include a third surface 28 which is configured to conform to at least a portion of the bonding surface 20 of the tooth 14 while leaving the area about the bracket 18 and the bonding surface 20 to which the bracket 18 will be secured open and free of obstruction. It is to be understood that the bonding surface 20 is the other of the lingual or labial side of the tooth that is not engaged by the second surface 26 of the tray 12. In other embodiments as disclosed herein, the tray 12 comprises primarily only the occlusal surface 22.

As previously disclosed, the arm 16 is movably secured to the tray 12. In the embodiment of the indirect bonding tray depicted in FIG. 1, the bracket arm 16 is pivotally connected to the tray 12 at a pivot 30. Further as previously disclosed, the arm 16 is designed to move between a first position wherein the arm and attached bracket 18 are pivoted away from the bonding surface 20 as depicted in dashed lines at reference number 32. The arm 16 rotates to a second position 34 wherein the bracket 18 engages, or, as described in further detail herein, is held in close proximity to the bonding surface 20 of the tooth 14 at the position digitally determined for proper bracket placement. The arm 16 further holds the bracket 18, in the second position 34, at a determined torque, tilt, or rotation required for proper placement of the bracket 18. Embodiments of the tray 12 may include a physical stop 36 that defines the second position 34 of the movable arm 16 by preventing further arm movement beyond the second position 34.

The bracket 18 includes an arch wire slot 38 and the arm 16 has a tip 40 configured to engage the arch wire slot 38. As depicted in FIG. 1, the tip 40 may engage the arch wire slot 38 in a friction fit engagement; however, other embodiments as described herein may include alternative engagements. It is to be noted that brackets 18 may include one or more slots, or a particular orientation of the slot or slots. A person of ordinary skill in the art recognizes that brackets may be formed with torque or angulation, exemplarily in the orientation of the arch wire slot to the rest of the bracket, to carry out predetermined orthodontic treatment of the patient. The tip 40 of the arm may be configured to engage the specific design of the slots in the bracket 18. Such configurations of the tip may be digitally designed relative to the specific brackets predetermined for orthodontic treatment of the patient. In further embodiments, a plurality of arms may each have differently shaped tips to accommodate the specific bracket or tube prescribed to the tooth to which the tray position and arm are associated.

FIG. 2 depicts an alternative embodiment of an indirect bonding tray 42. It is to be noted that like reference numerals are used herein to represent like features for purposes of conciseness and in order to focus on particular features as described herein.

The arm 44 depicted in FIG. 2 is movably connected to the tray 46 in a slidable manner such that the arm 44 moves the bracket 18 towards and away from the bonding surface 20 of the tooth 14 between a first position 32 and a second position 34. The tray 46 is configured with an aperture or guide 48 that is configured to receive a sliding portion 50 of the arm 44 such that the arm 44 can translate with respect to the tooth 14 and the tray 46. A stop 52 on the arm 44 engages the guide 48 structure in order to define the second position 34 of the arm 44 in the digitally configured proper placement of the bracket 18 in relation to the bonding surface 20. In some embodiments, a pin 54 may also be used to fixedly secure the arm 44 in the second position 34 in order to facilitate bonding of the bracket 18 to the patient's tooth. In an example, this bonding may occur by holding the bracket in the desired second position relative to the patient's tooth while the orthodontist cleans any excess flash from the bracket and bonding surface of the tooth before the composite and/or bonding material is cured.

FIG. 2 also depicts an alternative embodiment of the arm tip 56. In such an embodiment, the arm tip 56 further includes one or more pins 58 that extend from the arm 44. An elastic band 60 engages both the one or more pins 58 and exemplary tie wings of the bracket 18 in order to releasably secure the bracket 18 to the arm 44. This method of securing the arm tip 56 to the bracket 18 may be used in conjunction with or instead of the previously discussed friction fit engagement between the bracket 18 and the arm tip 56.

As will be described in further detail herein, in some embodiments, the bracket 18 may be customized with an additional composite base 62 on the bracket pad that is designed to fill any gap between the pad of the digitally positioned bracket 18 and the treatment surface 20 of the patient's tooth 14. The composite base 62 can thus facilitate a customized fit specifically configured to conform to a bonding surface 20 of the patient's tooth 14. Such use of a composite base may facilitate the use of a less complexly bended arch wire or may reduce or eliminate the need to custom manufacture brackets specific to the patient, composite bases may also be used to impart a torque and/or a rotation on the tooth 14.

FIG. 3 is a side-view depiction of a still further embodiment of an indirect bonding tray 64 in which the arm 66 is curved and slidably engages the guide 48 on the tray 46 in a curved manner. The guide 48 defines a movement path of the arm 66 such that when the arm 66 is in the first position (not depicted), the bracket 18 is rotated away from the treatment surface. A stop 68 on the arm engages the guide 48 to precisely define and hold the bracket 18 and arm 66 in the second position.

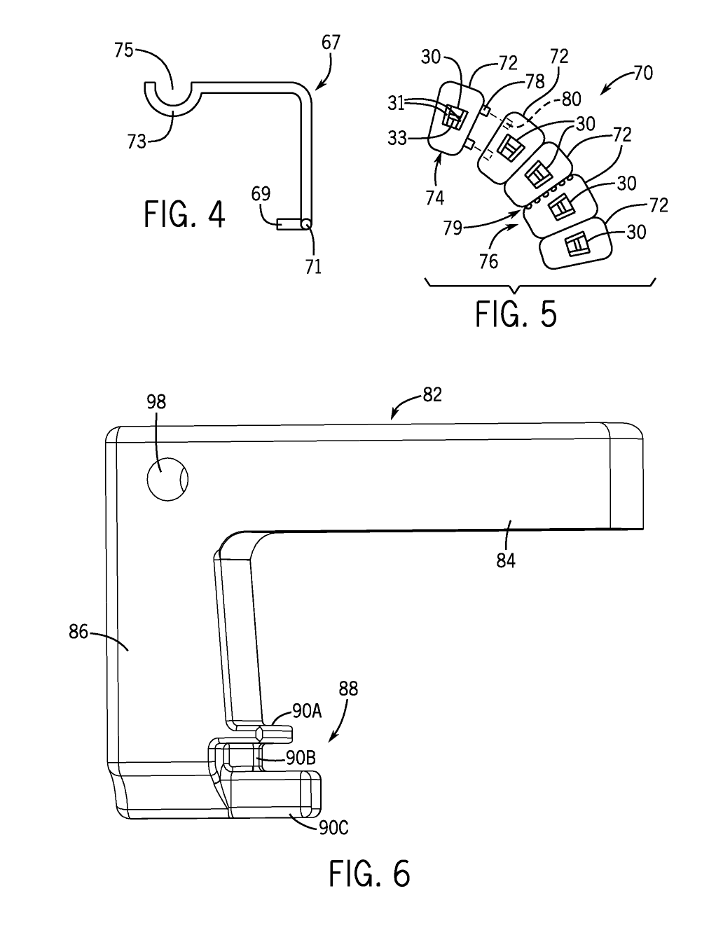

FIG. 4 is a side view depicting an exemplary alternative embodiment of an arm 67 for use with embodiments of an indirect bonding tray as disclosed herein. The arm 67 is configured to removably and pivotally engage a pivot 30. A top view of a merely exemplary embodiment of a pivot 30 is depicted in FIG. 5. The pivot 30 of FIG. 5 may exemplarily be the same pivot 30 as depicted in FIG. 1. The pivot 30 exemplarily includes pivot sides 31 and a pivot pin 33. It will be appreciated that in alternative embodiments, the pivot 30 may include only a single pivot side 31 which would facilitate receipt of an arm by sliding over an open end of the pivot pin 33. In another embodiment, the pivot 30 may be arranged with a vertically oriented pivot pin, exemplarily to facilitate rotational pivoting of an arm.

Referring back to FIG. 4, the arm 67 includes an arm tip 69 configured to engage a bracket (not depicted) and exemplarily including one or more pins 71 as described above with respect to FIG. 2 operable to further secure the bracket to the arm 67. The arm 67 further includes a rotation finger 73 that is shaped to form a rotation cavity 75 configured to removably and pivotally receive the pivot pin 33 of the pivot 30. In embodiments, the rotation finger 73 may be dimensioned such as to removably receive the pivot pin, but also to retain engagement of the pivot pin with the rotation cavity 75 as the arm is moved between both the first and second positions.

In a still further embodiment, the arm may include a ring or annulus (not depicted) configured to receive the pivot pin. Such an arm may exemplarily be configured similarly to that described with respect to FIG. 1, although when used in conjunction with a pivot that includes a single pivot side 31, facilitates the removable engagement with the pivot by slidably receiving the pivot pin within the annulus.

FIG. 5 is an occlusal view of a partial embodiment of an indirect bonding tray 70 wherein the indirect bonding tray 70 is constructed in the manner as described above with respect to FIG. 1, including the pivot 30. For the sake of clarity, the arms are not depicted in FIG. 5; however, it is to be recognized that in embodiments, arms would also be included. The arms may exemplarily be connected components as depicted with respect to FIG. 1, or may be removable arms as depicted in FIG. 4. Still further embodiments may be implemented in the sliding configurations of FIGS. 2 and 3, or any other disclosed embodiments as recognized in view of the current disclosure. The indirect bonding tray 70 depicted in FIG. 5 shows that in some embodiments, a full or partial arch of an indirect bonding tray can be formed by a plurality of tooth portions 72 that are designed to conform to either a single tooth as a single tooth portion 74 or to a group of teeth as groups 76 of tooth portions.

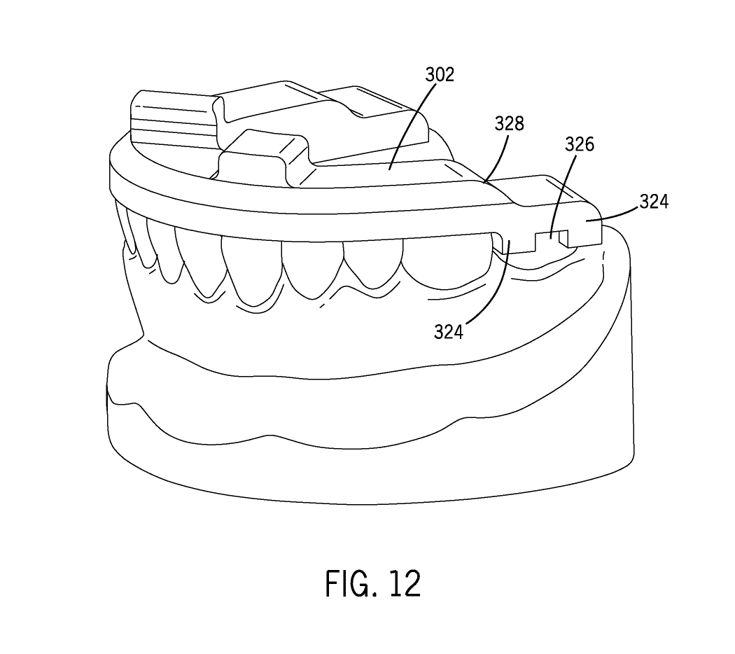

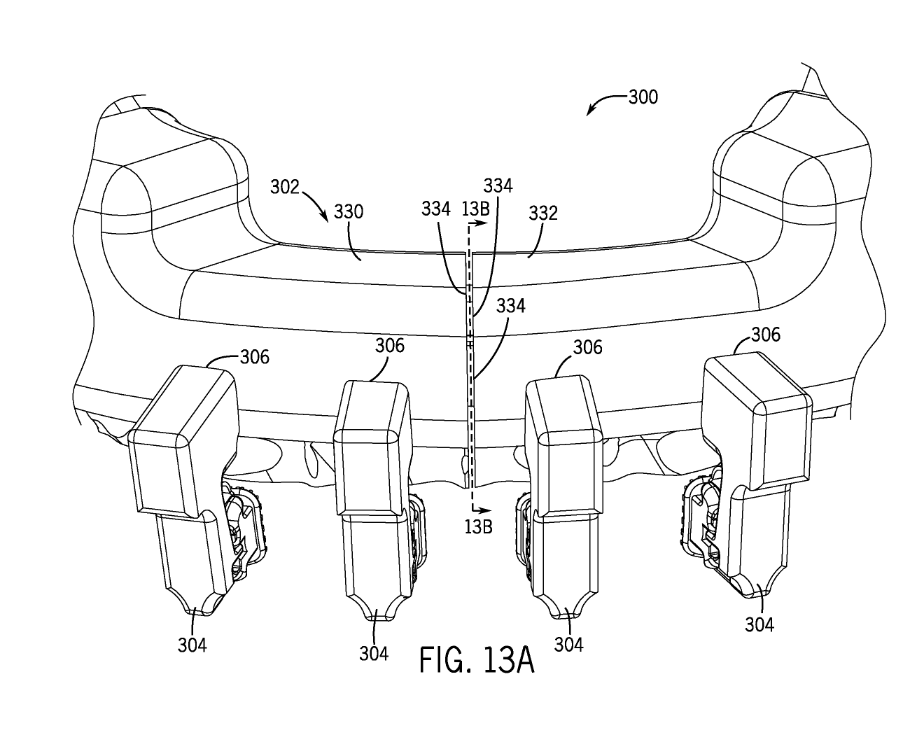

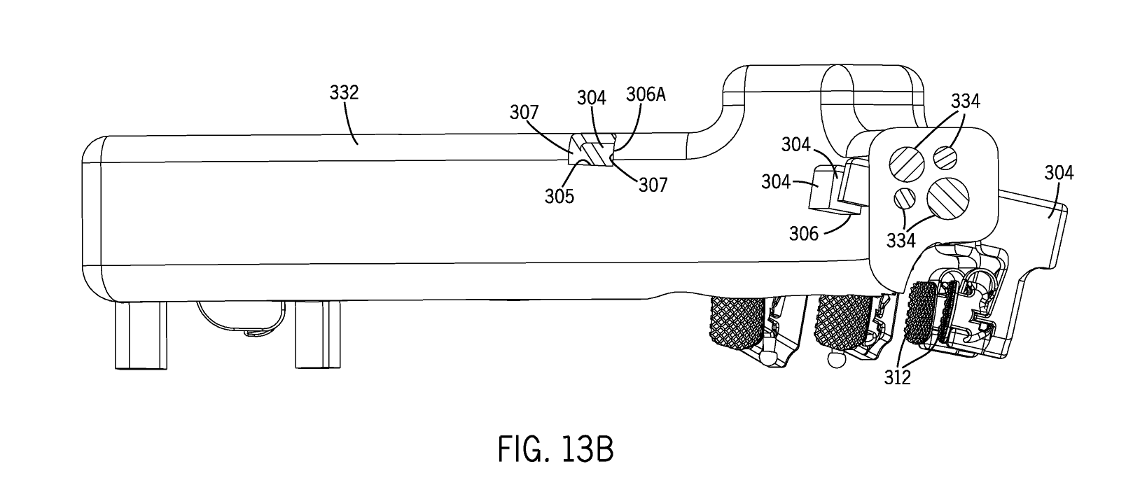

In an embodiment, the groups of teeth 76 may be constructed either as a unitary or separated/separable construction. In an additional exemplary embodiment as depicted in FIG. 12, tooth portions or groups of tooth portions may be connected by a material different from that used to construct the rest of the tray. Rapid prototyping, 3-D printing, and molding capabilities are availability for construction of such embodiments. The second material may be a material that is comparatively more flexible than the first material and facilitates placement of the tray on the patient's dentition. In another embodiment, the second material facilitates ease of cutting or tearing to separate portions of the tray. In further embodiments as depicted in FIGS. 13A and 13B, the connectors are physically smaller than the body of the tray and therefore facilitate separation of the portions of the tray by breaking, tearing, or cutting. In an exemplary embodiment, the connectors are exemplarily a plurality of rods extending between tray portions.

In a still further exemplary embodiment, an indirect bonding tray similar to that as depicted in FIG. 1 may be provided with a flexible material providing the pivot. In such an embodiment, the arm is secured to the tray by a portion of flexible material which enables the indirect bonding tray or indirect bonding tray portion to be constructed as a unitary structure. In use, the arm is pivoted about the portion of flexible material to move the bracket into a predetermined desired position. In another example of this embodiment, the arm is partially or completely constructed of a flexible material, enabling a greater degree of freedom of movement of the arm relative to the tray. In such an embodiment, the stop may further include a clip or registration feature that mates with the arm to secure that arm into a portion that places the bracket or tube secured to the arm in the predetermined desired position of placement on that patient's tooth.

Referring back to FIG. 5, it will be understood that in embodiments, any combination of single tooth portions 74 and/or groups of tooth portions 76 may be used to create an indirect bonding tray 70 that corresponds to a full or partial arch of a patient's dentition. In still further embodiments, a partial tray may be similarly formed in order to place brackets on only a portion of a patient's dentition. Tooth portions 72 can be configured to releasably attach to one another in order to form an indirect bonding tray 70, exemplarily through the use of mating a tab 78 with a slot 80. In an embodiment, each tooth portion 72 includes a set of tabs 78 and slots 80, such that adjacent tooth portions 72 are connectable. In still further embodiments, groups 76 of tooth portions 72 are connectable by similarly mating tabs 78 and slots 80. In an alternative embodiment, the bonding tray 70 may be formed as a unitary construction covering the dentition of an arch or a partial arch and individual teeth and/or portions of teeth of the indirect bonding tray 70 separated by perforations 79 that facilitate separation of the indirect bonding tray 70 into smaller segments. In an embodiment, each tooth portion 72 may be separable by perforations 79, while in other embodiments, perforations 79 separate groups of tooth portions 72.

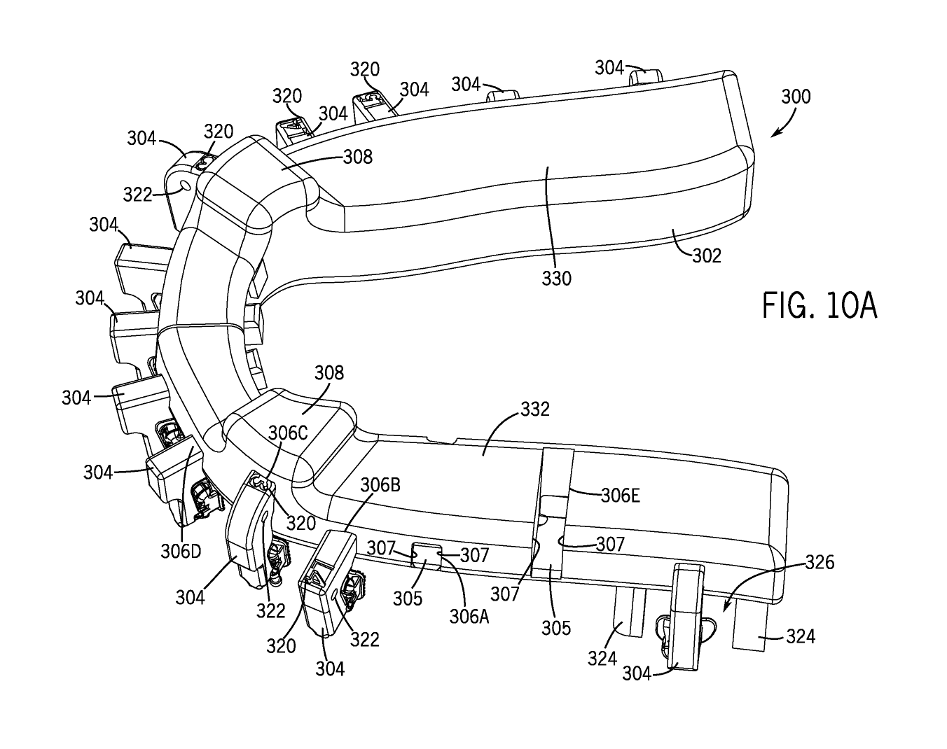

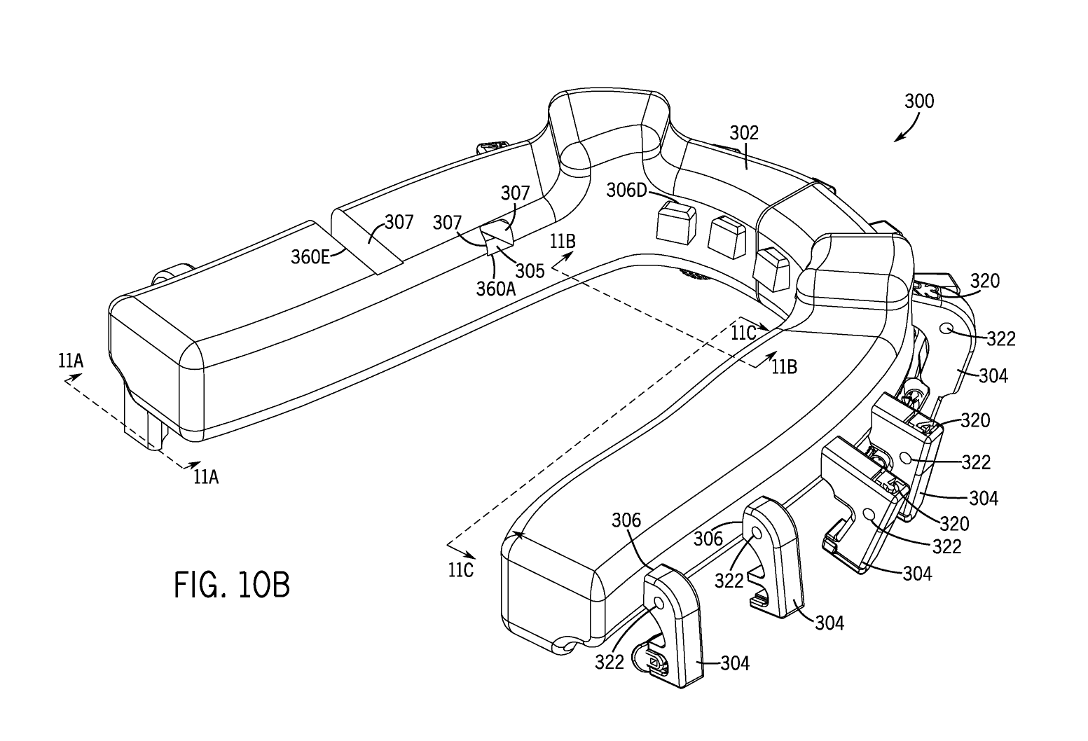

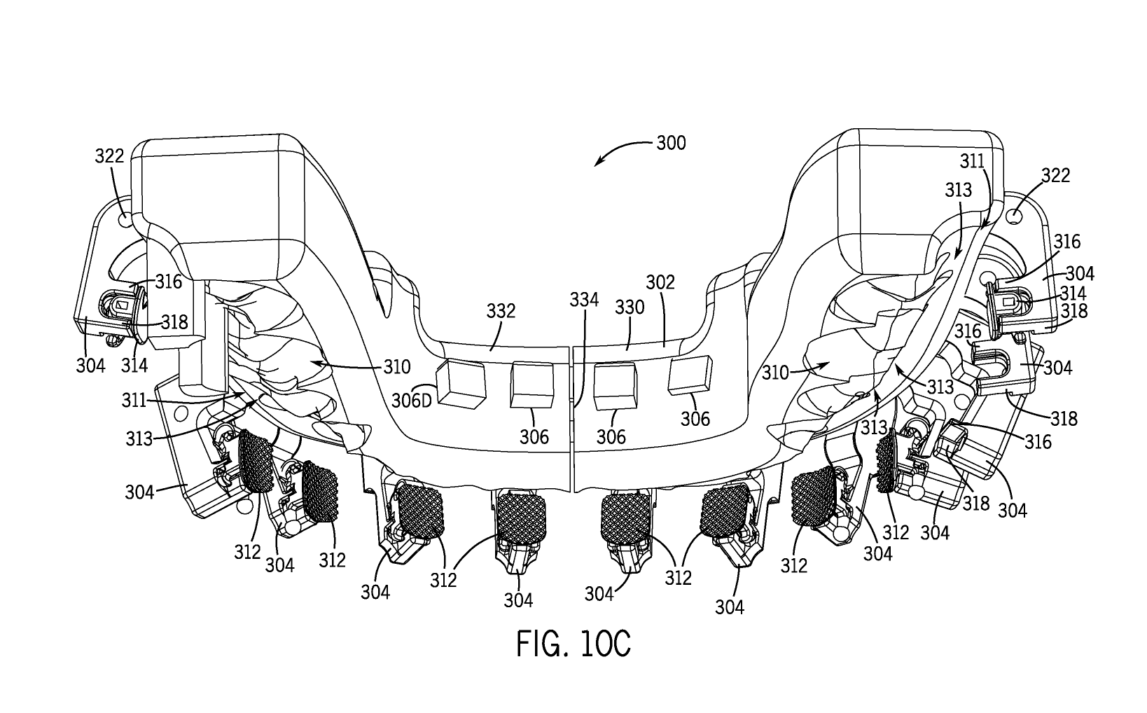

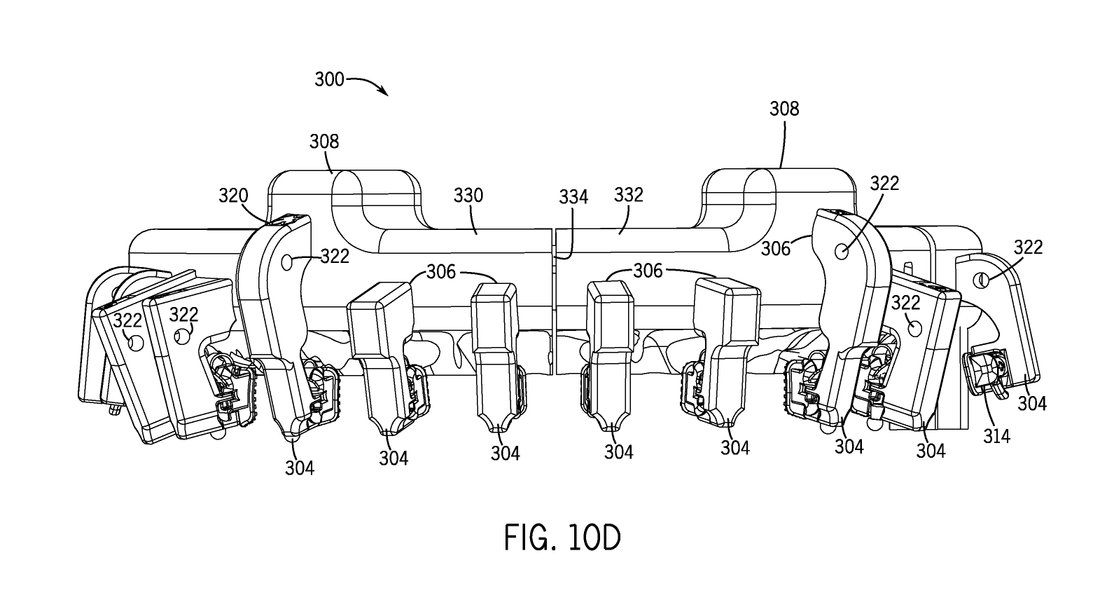

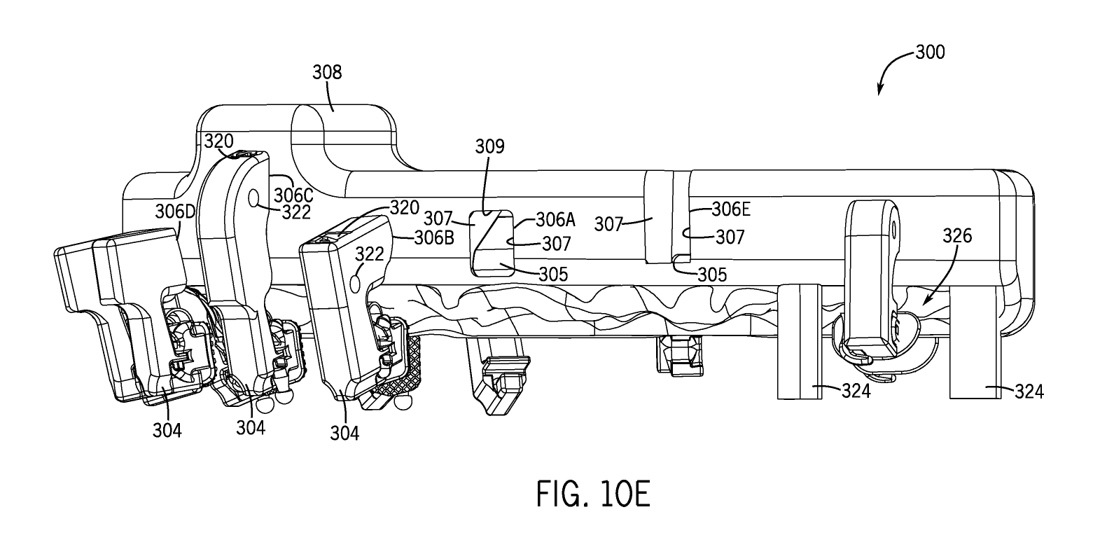

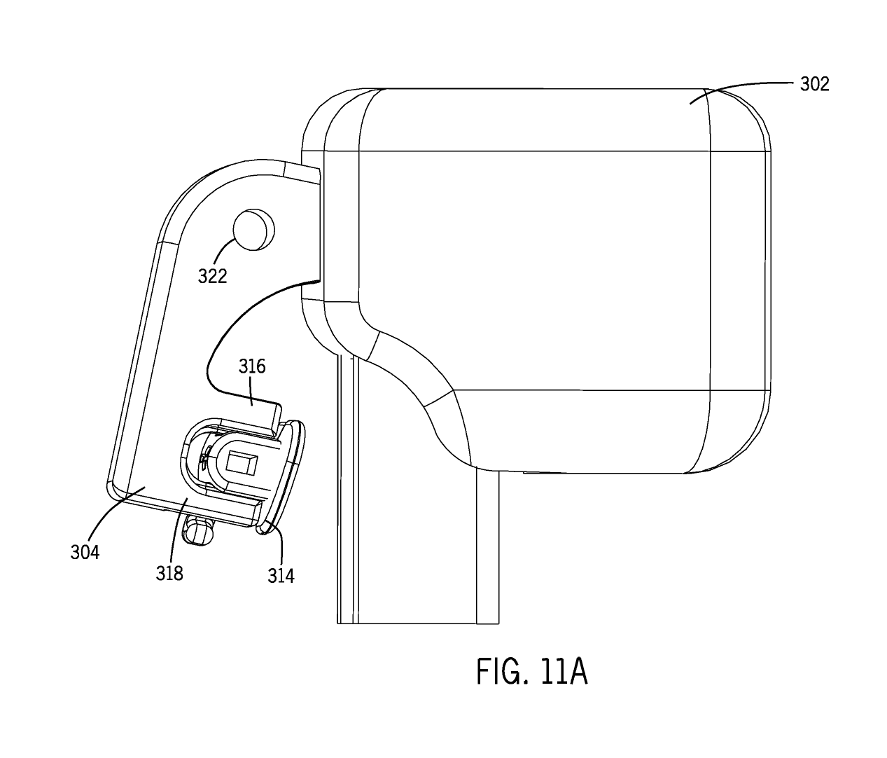

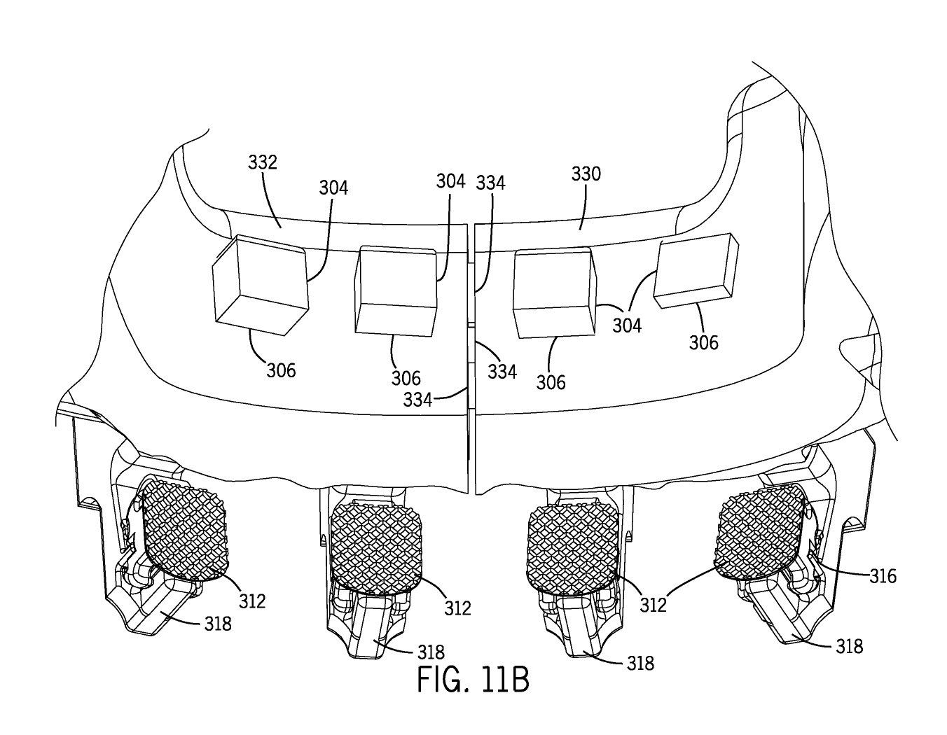

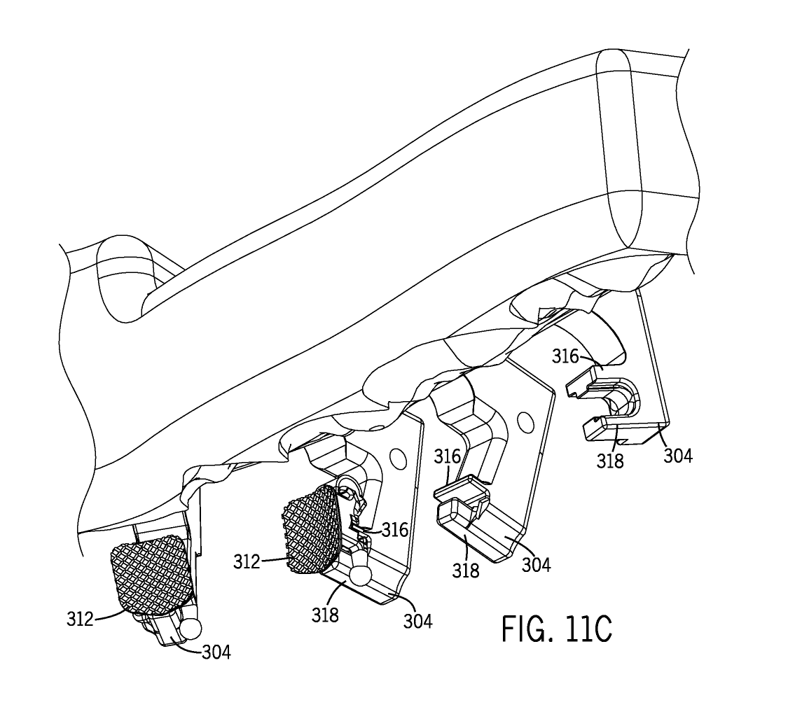

FIG. 6 depicts an exemplary embodiment of an arm 82 which may be used in connection with various embodiments of the indirect bonding tray as described herein. Exemplarily, an arm 82 may be used in connection with the tray embodiments described in further detail herein with respect to FIGS. 10 and 11. The arm 82 includes a slide portion 84 and an extension portion 86. In general, the slide portion 84 of the arm 82 is configured to movably engage the tray (not depicted). While the engagement may be a sliding engagement, as described in further detail herein that sliding engagement may be with an aperture (not depicted) in the tray which may further exemplarily be a hole or a trough as described herein, and the movable engagement between the arm 82 and the tray may include other forms of relative movement. The extension portion 86 is generally configured to hold the bracket, or in embodiments, a buccal tube, at a tip 88 thereof in a defined relation to the slide portion 84 that movably engages the tray. The arm 82 also includes an explorer hole 98, which is dimensioned and shaped to receive the tip of an orthodontist's explorer tool. This can facilitate movement of the arms 82 relative to the tray. Such feature may improve an orthodontist's ability to pull the arms 82 out for placing the indirect bonding tray in the patient's mouth or for removal of the indirect bonding tray after use. Such feature may also improve an orthodontist's ability to push the arms 82 in to place the brackets or tubes on the patient. While the explorer hole 98 is depicted as a cylindrical hole orthogonal to both the slide portion 84 and the extension portion 86, in other embodiments, the explorer hole 98 may be of a different shape and orientation, including, but not limited to, parallel or coaxial to the extension portion 86.

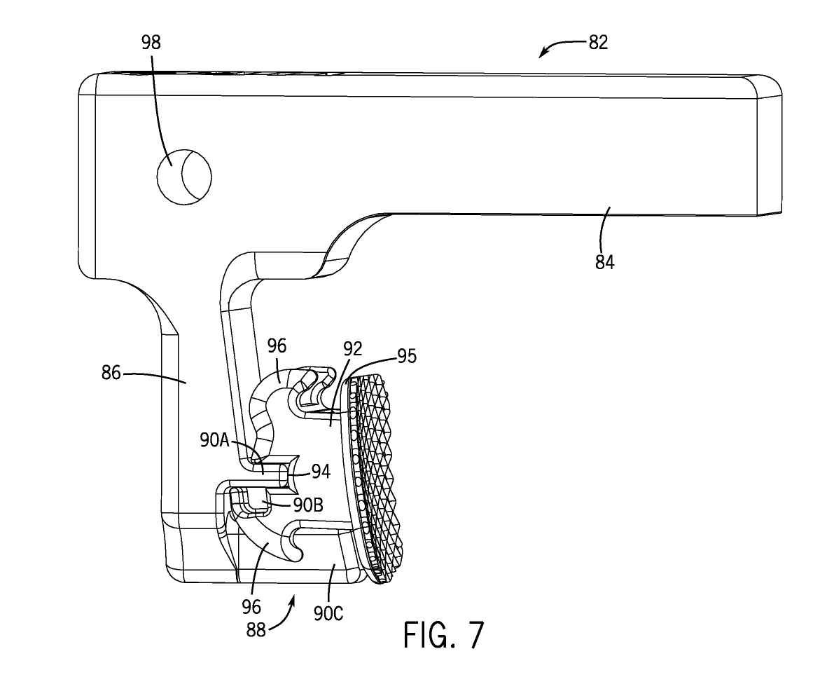

The tip 88 of the arm 82 includes at least one finger 90, but in other embodiments, a plurality of fingers 90A-C may be present. The fingers 90A are configured to engage a bracket or buccal tube. FIG. 7 depicts another exemplary embodiment of an arm 82, with a bracket 92 engaged to the tip 88 of the arm 82. In embodiments one or more fingers 90A-C are dimensioned to engage the bracket 92. Exemplarily, finger 90A engages the bracket 92 in the arch wire slot 94. Finger 90B engages the bracket 92 in a space labially between two gingival tie wings 96. Finger 90C engages the bracket 92 in a space gingivally between the two gingival tie wings 96. In an embodiment, the finger 90C further engages a bracket pad 95 of the bracket 92. In embodiments, the fingers 90A-C may form a friction fit with at least a portion of the bracket 92 to releasably secure the arm 82 to the bracket 92. In another embodiment, the fingers 90 are dimensioned relative to each other to resiliently deform when engaged with one or more structures of the bracket 92 to releasably secure the arm 82 to the bracket 92. In an embodiment, the tip 88 and/or fingers 90 may be constructed of a material different from another portion of the arm 82, exemplarily the slide portion 84 or the rest of the extension portion 86. The material used to construct the tip 88 and/or fingers 90 may be flexible or pliable to further facilitate engagement between the bracket 92 and the tip 88.

As noted above, in exemplary embodiments, the arms may be constructed of stock, mass produced, or similar components. In one embodiment, the same arm design may be used for each tooth in the patient's dentition. In such embodiment, all of the customization to properly locate the bracket or tube relative to each tooth in the patient's dentition is incorporated into the custom designed tray with apertures designed to receive the arms into a position to properly seat the bracket or tube on the dentition of the patient. In another embodiment, the same arm design may be used for all brackets to be placed on teeth in the same anatomical location. In such an embodiment, the arm for a particular anatomical tooth location may include an identifier as described in further detail herein.

In such an embodiment, an angulation of the aperture in the tray associated with the arm defines the resulting position (e.g. orientation, location, angulation, torque, tilt) of an attached orthodontic appliance on the patient's tooth. It will be recognized by a person of ordinary skill in the art that while there may be torque, tilt or rotation relative to the arch wire built into the bracket or tube itself, that the bracket and/or tube must also be positioned relative to the tooth. In an exemplary embodiment, the identifier may be the Federation Dentaire Internationale (FDI) number or the International Standards Organization (ISO) notation system identifier, while those of ordinary skill in the art will recognize other notations which may be used as a location identifier. In an exemplary embodiment, standardization of the arms either in part or in total further enables the arms to be produced economically in other manufacturing manners such as by casting or injection molding. In a plastic injection molded embodiment, a color coding of the material of the entire arm may be used to identify anatomical location in whole or in part (e.g. specific tooth or tooth quadrant). In another embodiment, cast metal or metal injection molded (MIM) arms may be used as reusable components. An orthodontist may therefore own a set of reusable arms and need only be provided with a custom made tray for the arms to be inserted into.

FIGS. 10A-E depict various views of a further exemplary embodiment of an indirect bonding tray 300. FIGS. 11A-C depict further close up views of the exemplary embodiment of the bonding tray 300 as respectively taken along the views indicated by lines A-A, B-B, and C-C in FIG. 10B. Unless otherwise specified, the present description will refer to each of these figures for the structures depicted therein. The indirect bonding tray 300 includes a tray 302 and a plurality of arms 304 which movably engage the tray 302 within apertures 306. As depicted in this embodiment, apertures 306 may include holes (e.g. 306A-306D) or may include troughs (e.g. 306E). Apertures 306 are exemplarily defined by a gingival wall 305 and opposed aperture sidewalls 307 defined in the tray 302. In embodiments wherein the aperture 306 is a hole, the aperture 306 is further defined by an occlusal wall 309. Together these structures are dimensioned as described herein to define in whole or in part the predetermined position of the orthodontic apparatus relative to the patient's tooth. Even comparing apertures 306 which are holes (e.g. 306A-306D), the apertures may extend all the way through the tray 302 as embodied by holes 306A and 306D, while other holes (306 B and 306C) terminate within the tray 302. The tray 302 may further include one or more projections 308 which are configured to create more volume of the tray 302 in a localized area within which a hole 306 may extend. This may be particularly useful when teeth are crowded or positioned relative to one another that holes of the position required to properly seat an associated bracket or tube would result in overlapping arms 306 when positioned within the tray 302.

As noted above, and best depicted in FIGS. 10A, 10B, and 10E, the dimensions and/or orientation of the apertures 306 may partially or wholly define the predetermined desired position of the orthodontic appliance relative to the patient's tooth. Furthermore, in embodiments the aperture defines a translation of the associated arm that maintains the arch wire slot of the bracket secured to the arm on an arch wire plane of the tooth as described above used to determine the digitally predetermined position of the bracket on the patient's tooth. Therefore, the aperture may angle in one or more of mesially, distally, labially, and lingually, as well as be rotated relative to a normal surface of the tray. By control of these degrees of freedom in the placement of the aperture in the tray, the tray can be customized to receive the arm with the orthodontic appliance and guide the arm and orthodontic appliance to the predetermined desired location on the patient's tooth. This is exemplarily seen in holes 306A-D and the orientations of the respective arms 304 received therein.

As explained above, embodiments maintain alignment between the arch wire slot of a bracket and an arch wire plane of an associated tooth. In such an embodiment, the pre-treatment position of the tooth and the orientation of the bonding surface may at least partially dictate the orientation and/or position of the aperture. In an embodiment, this may result in overlapping of two or more apertures. In an embodiment, this may result in the need to place the associated bracket sequentially. A first arm is used in a first aperture to place a first bracket, after which the arm is withdrawn and a second arm is used in the second aperture (which overlaps a portion of the first aperture) to place the second bracket. As described above, in other embodiments, projections 308 may provide additional volume to one or more localized areas of the tray 300 to provide an aperture with the desired orientation.

While similar aspects apply to apertures which are holes, apertures which are troughs are configured wherein respective sides of the trough slidably engage the slide portion of the arm while permitting the additional degree of freedom in the generally occlusal-gingival dimension to facilitate orthodontist placement of the orthodontic appliance as described in further detail herein. Therefore in embodiments, at least one wall of the aperture defines the predetermined position of the arm (and bracket secured to the arm) relative to the bonding surface of the associated tooth. In still further embodiments, the at least one wall further defines the translation of the arm as described above to maintain bracket arch wire slot alignment with the arch wire plane of the associated tooth.

As best seen in FIG. 10C, the tray 302 has an occlusal surface 310 configured specifically to correspond to the occlusal surfaces of the dentition of a patient. In embodiments, the occlusal surface 310 of the tray 302 is further defined by a labial ledge 311. The labial ledge extends labially away from one or more crown portions 313 of associated regions of the occlusal surface 310. The one or more crown portions 313 are associated to or adapted to fit a crown of an associated tooth. By extension of the labial ledge 311 of the tray 302 from one or more crown portion 313, the entire labial tooth surface, or nearly the entire labial tooth surface is exposed while the indirect bonding tray 300 is engaged with the patient's dentition. This promotes visual confirmation of bracket placement and maximizes an area surrounding the bracket on the tooth surface for clean up of excess flesh from the bracket bonding process.

It will be recognized that in some embodiments, due to the specific pre-treatment location of one or more teeth, while the tray 302 includes an occlusal surface 310 that is adapted to engage associated teeth of a patient's pre-treatment dentition, there may be one or more teeth that are not engaged by the occlusal surface 310. For example, if a tooth is particularly labial or lingual in eruption, or fully or partially inaccessible due to excessive crowding, the crown of the tooth may not extend to the occlusal surface 310 and/or labial ledge 311 of the tray 302. In embodiments, the aperture(s) 306 may still be defined in the tray 302 for that tooth and facilitate bracket placement on the tooth as described in the present application.

The indirect bonding tray 300 further includes a plurality of arms 304. Each of the arms 304 is further configured to releasably engage a bracket 312 or a tube 314. As described above, the arms 304 include at least one finger 316, 318. The finger 316 may exemplarily be an occlusal finger, and a finger 318 may exemplarily be a gingival finger. However, it will be recognized by a person of ordinary skill in the art that the one or more fingers of the arms may be oriented in another manner or be adapted for engagement with an orthodontic appliance in other manners than as described herein with respect to the depicted embodiment. In the embodiment depicted, and as best seen in FIGS. 11A-11C, the occlusal finger 316 may be configured to be inserted within the arch wire slot of the bracket 312, which may exemplarily be a self-ligating bracket. The gingival finger 318 may be configured to engage the bracket body of the bracket 312 between the tie wings of the bracket 312. As further depicted, the gingival finger 318 may further engage the bracket body along the side of the bracket and terminate in engagement with the bracket pad of the bracket 312. In an arm 304 configured to engage a buccal tube 314, the occlusal finger 316 and the gingival finger 318 may be configured to engage the buccal tube on respective occlusal and gingival sides of the tube. Exemplarily, the fingers 316 and 318 may be configured to engage buccal tube positioning guides which are features on the tube designed for engagement with a tweezers or other orthodontic tool for placement of the tube. In another embodiment (not depicted) the fingers may be dimensioned to engage respective mesial and distal ends of the buccal tube 314. Embodiments of fingers 316 and 318 may also be dimensioned to engage a pad of the buccal tube 314.

As best depicted in FIGS. 10B and 10D, each of the arms 304 may be marked with an identifier 320 which identifies the anatomical position of the tooth with which that arm 304 is associated. The identifier 320, may in an embodiment be an alpha-numeric combination, a symbol, or both, but a person of ordinary skill will recognize other identifiers which may be used. In an exemplary embodiment, the identifier 320 is the FDI number of the tooth to which that arm is associated. In an exemplary embodiment, the identifiers 320 may be formed in the respective arms 304 by depression or in relief. In still further embodiments, for example in injection molded or 3-D printed embodiments including multiple colors/material, the identifier may be a different material and/or color of material. In a still further embodiment, a majority of the arm 304 may be constructed of a translucent or transparent material and/or materials while the identifier 320 is a material of another color or opacity, and the identifier 32 is located internal to the rest of the material of the arm 304. The identifier 320 may then be visible through the other material(s) of the arm 304.

The arms 304 further include an explorer hole 322 which is located and dimensioned to receive a tip of an orthodontist's explorer tool. The interaction between the tool tip and the explorer hole 322 facilitates movement of each of the arms 304 relative to the tray 302 and the dentition of the patient (not depicted). In an embodiment, the identifier 320 is positioned on the arm 304 in such a manner that the identifier further acts as a depth indicator of the position of the arm 304 within the tray 302. In an embodiment, a particular portion of the indicator 320 aligns with a portion of the tray 302 to provide the depth indication. In an exemplary embodiment, a lingual end of the indicator 320 is positioned such that if the entire indicator 320 is visible, the arm 304 is withdrawn from the tray 302 a suitable distance for placement of the indirect bonding tray 300 on the dentition of the patient. If the labial end of the indicator 320 is positioned such that if none of the indicator 320 is visible, then the arm 304 has been inserted to the proper depth relative to the patient's dentition for placement of the bracket or tube. In a still further embodiment, the arm may include one or more lines, scribes, or other visible features to indicate position of the arm 304 relative to the tray 302. In still further embodiments, particularly those in which the arm and apertures in the tray are dimensional to move the bracket along the associated arch wire plane, no physical stop is used to define proper insertion of the arm into the tray. Rather, engagement between the bracket pad and the tooth is relied upon to define the stop of inward movement of the arm.

As best depicted in FIGS. 10A and 10E, embodiments of the tray 302 may include adaptations to further facilitate buccal tubes 314 on molars of the patient. Molars are typically located gingivally compared to the crowns of the other teeth, as well as the anatomy of the gums and mouth at the back of the mouth can limit the area available for an orthodontist to work to secure a buccal tube to the bonding surface of a molar. Additionally, impaction or partial impaction of a molar may limit height availability to place the buccal tube. One solution to this problem is to position a buccal tube such that the buccal tube pad extends sub-gingivally, leaving the tube itself above the gum line. Embodiments of the indirect bonding tray 300 may be adapted to facilitate these alternative placement techniques. Exemplarily, such an indirect bonding tray 300 may include an aperture that is a trough 306E. The arm (not depicted, but exemplarily as described above with respect to other arms) slidingly engages the trough 306E, which maintains alignment of the arm, while enabling the orthodontist to tilt the arm and buccal tube gingivally and lingually to insert the edge of the buccal tube bonding pad below the gumline. Sliding engagement between the arm and the side walls generally direct the bracket towards the predefined position, while the openness of the trough in the occlusal dimension enables the bracket to be tilted gingivally to be positioned with at least a portion of the pad below the gumline. Engagement of the arm with the bottom of the trough 306E and continued engagement of the arm with the side walls of the trough 306E ensures that the buccal tube is finally positioned on the tooth at the predetermined desired position.

In a still further embodiment, the tray 302 may include gingival projections 324 which form a notch 326 configured to guide and locate the buccal tube 314 in the predetermined desired location. FIG. 12 depicts a further exemplary embodiment of a tray 302 that includes gingival projections 324 which define a notch 326 for placement of a buccal tube (not depicted) on a molar (e.g. second molar). While not depicted in FIG. 12, it is understood that in an embodiment, apertures and arms may be incorporated to form an indirect bonding tray as described above for the placement of brackets and/or tubes on the rest of the patient's dentition (e.g. apart from the molars or other locations where a notch as described herein is used). The tray 302 depicted in FIG. 12 further includes a step 328 that eliminates volume of the tray 302 in the region of the second molar as the gingival projections 324 and notch 326 are provided for placement of the buccal tube and an arm and aperture as described above are not needed. In an embodiment, such a notch 326 may be referred to as a bonding guide, as the orthodontist may directly bond the buccal tube to the tooth with the guidance of the notch 326. Therefore, in an embodiment, the indirect bonding tray may be a hybrid tray that incorporates the arms and apertures with respect to a plurality of teeth, but also incorporates at least one notch for placement of at least one orthodontic appliance. In a further exemplary embodiment of a hybrid indirect bonding tray, a combination of holes, troughs, and notches may be formed in the tray to provide a best combination of placement features to the orthodontist. In an exemplary embodiment, troughs may be used in a mandibular tray for placement of orthodontic appliances on mandibular molars while notches are provided in a maxillary tray for placement of orthodontic appliances on maxillary molars. Such an embodiment results in a tray in which the support of the arms/orthodontic appliances during placement is maximized for orthodontist's convenience for each tooth or group of teeth.

Exemplary embodiments of the notch 326 may include one or more registration feature to facilitate proper placement of the buccal tube on the tooth. In an embodiment, the notch 326 is dimensioned such that the buccal tube and pad fit into the notch at a precise orientation and position of the buccal tube. Other registration features may include physical projections that engage a portion of the tube or the pad surrounding the tube to define a proper position for the buccal tube on the tooth. In still further embodiments, the gingival projections may incorporate a visual guide for example to align with an orientation feature on a tube or the hole of the tube to facilitate proper locating of the tube on the tooth.

As depicted in FIGS. 10A-10E, but best depicted in 11B, 13A, and 13B, an exemplary embodiment of the indirect bonding tray 300 includes a tray 320 that is constructed from two or more tray portions, e.g. 330 and 332. While two tray portions are depicted in these figures, it is understood that other embodiments may be constructed of more than two tray portions. Adjacent tray portions 330, 332 are exemplarily connected by connectors 334 that extend between the tray portions 330, 332. In an exemplary embodiment, the connectors 334 are cylindrical projections, although it will be recognized that the connectors 334 can take other physical forms as well. In an embodiment, the connectors 334 provide an area of weakness, facilitating separation of the tray portions 330, 332 exemplarily by breaking or cutting. FIG. 13B is a sectional view taken along line B-B of FIG. 13A. FIG. 13B exemplarily depicts that there may be a plurality of connectors 334 and that the connectors 334 may be of a varied thickness.

In a still further embodiment, the connectors 334 may be constructed of a more pliable or deformable material than the rest of the tray portions 330, 332. Exemplarily, a rigid and inflexible material is desirable for the tray portions 330, 332, particularly the portions which form the apertures. However, with a rigid construction, there may be little flexibility in the tray 302 which may adversely affect patient comfort when the tray 302 is placed into engagement with the patient's dentition. At least one region of flexibility, exemplarily provided by connectors 334 between the tray portions 330, 332 and made of a flexible material provides a limited degree of flexibility of the trays 302 which has been found to improve patient comfort.

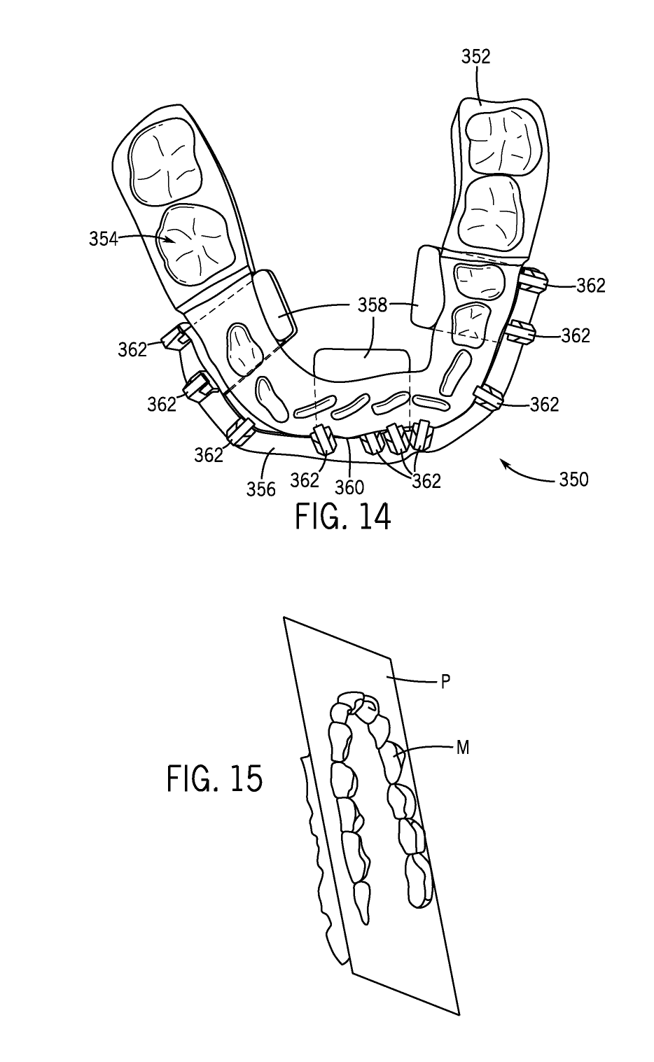

FIG. 14 depicts a still further exemplary embodiment of an indirect bonding tray 350. The indirect bonding tray 350 includes a tray 352. The tray 352 includes an occlusal surface 354 configured to correspond an occlusal surface of the dentition of a specific orthodontic patient to be treated. The indirect bonding tray 350 further includes a combined arm 356 that is configured to locate a plurality of orthodontic appliances to the dentition of the patient. In the embodiment depicted, a single combined arm 356 is used, however, it will be recognized that in an alternative embodiment more than one combined arm 356 may be used, exemplarily by separating the combined arm 356 into two or more pieces.

The combined arm 356 movably engages the tray 352 exemplarily by being constructed of a flexible material such that the combined arm 356 engages the tray 352 by friction fit. Lingual projections 358 wrap around the tray 352 and engage the tray 352 from the lingual side. A labial ridge 360 resiliently engages the tray 352 from the labial side. Due to a mating of the shapes of the respective lingual portions 358 and labial ridge 360 with the tray 352, the combined arm 356 engages the tray 352 at a particular predetermined orientation in order to properly locate the orthodontic appliances on the dentition of the patient. A plurality of arm portions 362 are configured with tips 364 to resiliently engage a portion of the orthodontic appliance to be secured, exemplarily an arch wire slot, one or more tie wings, a tube body or a tube end. In practice the orthodontist engages the patient's dentition with the occlusal surface 354 of the tray 352. Then the orthodontist movably engages the combined arm 356 loaded with the respective orthodontic appliances with the tray 352 by deforming the combined arm 356 about the tray 352 to engage both the lingual projections 358 and the labial ridge 360 with the tray 352. Once the orthodontic appliances are secured to the patient's dentition, the orthodontist can easily remove the flexible combined arm 356 without disturbing the newly placed orthodontic appliances.

In further embodiments. A tray or tray portion as described above may further include a placement handle configured to facilitate orthodontist gripping of the tray or tray portion for placement or removal of the tray from the patient's dentition. In embodiments, the placement handle can extend from an exterior of the tray in at least one of the occlusal and labial directions.

As described above, embodiments of the indirect bonding tray as described herein can include a custom composite base 62 applied to each of the brackets 18 in order to provide an individualized fit between the brackets and the treatment surface of the patient's teeth.

FIG. 9 is a flow chart that depicts an embodiment of a method 200 that may be performed in conjunction with the method 100 shown in FIG. 8 in order to provide an indirect bonding tray with brackets that have custom composite bases. In the method 200 the indirect bonding tray with attached brackets as from reference 120 in the method 100 of FIG. 8 are used at 202 to begin the method 200. At 204 a physical dental model of patient's pre-treatment dentition is obtained. As described above, in some embodiments, a physical dental model may be a plaster or composite material cast of the patient's pre-treatment dentition, and may be the same model that was scanned in step 102 in order to obtain a 3-D digital model of the patient's dentition. In an alternative embodiment, the physical dental model obtained at 204 may be a new model obtained if later it is determined that individualized composite bases are to be created for the patient.

At 206 the indirect bonding tray with the attached brackets as produced according to the method 100 (FIG. 8) is used and a composite material is applied to the pad of each bracket in the indirect bonding tray. In embodiments, the composite material may be selected from a variety of available dental composite materials, including, but not limited to, (UV) light curing, chemical curing, or thermal curing materials. The indirect bonding tray is seated on the physical dental model at 208.

Next, at 210, the arms of the indirect bonding tray are used to seat each bracket on the physical model such that the composite material fills the gaps between the bracket pads and the tooth surfaces on the physical model. It is to be recognized that in practical performance of this method, the physical dental model may be treated with a release agent, such that the composite material does not stick or adhere to the physical dental mode after curing of the composite material. At 212 any composite material that excretes beyond the edge of the bracket pad is cleaned or removed and the remaining composite material is cured at 214. Non-limiting examples of the curing process for the composite material may include a UV curing, chemical curing, or heat curing process depending upon the specific composite material used for the base.

After the custom composite material bases have been created and cured, two alternative options exist for providing the indirect bonding tray to an orthodontist. In one embodiment, the composite bases are released from the physical model of the patient's pre-treatment dentition and the arms are rotated into the first position such that the indirect bonding tray as described herein can be provided to an orthodontist with the custom composite bases.

In an alternative embodiment, the arms are disconnected from the brackets and the brackets with the custom composite bases are left on the physical dental model of the patient's pre-treatment dentition. The indirect bonding tray, including the arms, is removed from the physical dental model. Next, a conventional indirect bonding tray, such as one formed from silicone or other polymeric material which exemplarily may be formed by a vacuum molding process is formed around the physical dental model and the brackets with the custom composite bases. The conventional indirect bonding tray is then removed from the physical dental model with the encapsulated brackets with custom composite bases and the conventional indirect bonding tray with the custom composite bases is provided to the orthodontist.

Embodiments of the indirect bonding tray and methods as disclosed herein improve upon previous indirect bonding techniques. Ideal bracket placement is determined digitally and a custom, patient specific, indirect bonding tray with movable bracket placement arms is produced to ensure that the brackets are placed on the patient's teeth at the previously determined ideal bracket placements. The disclosed arms allow the brackets to be precisely and repeatedly positioned at the digitally determined ideal bracket placement with or without custom composite bases on the bracket pad. Embodiments that include computer controlled custom composite bases on the bracket pads further individualize the fit of the bracket to each tooth surface in the patient's dentition.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An indirect bonding tray for use in positioning of a plurality of orthodontic appliances, the indirect bonding tray comprising:
a tray comprising an occlusal surface adapted to conform to occlusal surfaces of associated teeth of a patient's dentition and a plurality of apertures extend at least partially through the tray;
a plurality of arms, each arm comprising a slide portion and a tip, the tip adapted to releasably engage an orthodontic appliance of the plurality of orthodontic appliances, wherein each slide portion of the plurality of arms movably engages an aperture of the plurality of apertures;
wherein the apertures are individually oriented such that movement of the slide portions of each of the plurality of arms within each of the apertures of the plurality of apertures moves the arms between a first position and a second position relative to the tray, wherein in the first positions the tip of each arm of the plurality of arms is in a position away from the tray, and in the second positions, each arm of the plurality of arms is in a position to hold an orthodontic appliance of the plurality of orthodontic appliances in a predetermined treatment position relative to a bonding surface of an associated tooth.

2. The indirect bonding tray of claim 1, wherein each aperture of the plurality of apertures is defined by at least a gingival wall and a pair of opposed sidewalls and the gingival wall and pair of opposed sidewalls are dimensioned to establish the predetermined treatment position of the orthodontic appliance relative to the bonding surface of the associated tooth.

3. The indirect bonding tray of claim 2, wherein at least one aperture of the plurality of apertures is a trough.

4. The indirect bonding tray of claim 2, wherein at least one aperture of the plurality of apertures is a hole, and the hole is further defined by an occlusal wall.

5. The indirect bonding tray of claim 2, further comprising at least one notch defined between gingival projections, the at least one notch defining a predetermined position of another orthodontic appliance on a bonding surface of another associated tooth.

6. The indirect bonding tray of claim 2, wherein the tray comprises a tray body with a thickness in the gingival-occlusal dimension between the occlusal surface and an exterior surface, the thickness being greater than a thickness in the gingival-occlusal dimension of the slide portions of each of the plurality of slide arms.

7. The indirect bonding tray of claim 1, wherein the orthodontic appliance is a bracket and the tip of each arm of the plurality of arms comprises a first finger and a second finger, the first finger releaseably engages an arch wire slot of the bracket, and the second finger releasably engages an occlusal side of the bracket.

8. The indirect bonding tray of claim 7, wherein the slide portion of each arm of the plurality of arms is constructed of a first material and the tip of each arm of the plurality of arms is constructed of a second material, the first material being different from the second material and the second material being more flexible than the first material.

9. The indirect bonding tray of claim 1, wherein the orthodontic appliance is a buccal tube and each arm of the plurality of arms comprises an occlusal finger and a gingival finger, and the occlusal finger and the gingival finger resiliently engage the buccal tube.

10. The indirect bonding tray of claim 1, wherein each arm of the plurality of arms further comprises:
an explorer hole extending through a portion of the arm; and
a depth indicator located on the slide portion, an alignment of the depth indicator with a predefined portion of the tray indicating that the arm is in the second position.

11. The indirect bonding tray of claim 1, wherein the tray comprises a first tray portion and a second tray portion, each of the first tray portion and second tray portion comprising at least one aperture of the plurality of apertures and the first tray portion is separably secured to the second tray portion.

12. The indirect bonding tray of claim 11, further comprising at least one connector extending between the first tray portion and the second tray portion, wherein the first and second tray portions are constructed of a first material and the at least one connector is constructed of a second material, the first material being different from the second material.

13. An indirect bonding tray system for positioning at least one orthodontic appliance, the indirect bonding tray system comprising:
a first tooth portion comprising an occlusal surface that conforms to an occlusal surface of a first specific tooth of a patient's dentition, the first tooth portion having a first tray body that extends in a gingival-occlusal dimension between the occlusal surface and an exterior surface, and a first aperture in the first tray body;
a first orthodontic appliance;
a first arm comprising a first arm tip that engages the first orthodontic appliance, the first arm movably engaged to the first aperture of the first tooth portion to move between a first position and a second position within the first aperture; and
wherein the first aperture is digitally designed relative to a predetermined placement for the first orthodontic appliance on the first specific tooth such that the first aperture is dimensioned to hold the first arm and first orthodontic appliance in the predetermined placement relative to a bonding surface of the first specific tooth when the first arm is in the second position.

14. The indirect bonding tray system of claim 13, further comprising:
a second tooth portion comprising an occlusal surface that conforms to an occlusal surface of a second specific tooth of the patient's dentition, the second tooth portion having a second tray body that extends in the gingival-occlusal dimension between the occlusal surface and an exterior surface, and a second aperture in the second tray body;
a second orthodontic appliance;
a second arm comprising a second arm tip that engages the second orthodontic appliance, the second arm the second arm movably engaged to the second aperture or the second tooth portion to move between a first position and a second position within the second aperture; and
wherein the second aperture is digitally designed relative to a predetermined idealized placement for the second orthodontic appliance on the second specific tooth such that the second aperture is dimensioned to hold the second arm and second orthodontic appliance in the predetermined idealized placement relative to the bonding surface of the second specific tooth when the second arm is in the second position; and
wherein the first tooth portion is separably secured to the second tooth portion.

15. The indirect bonding tray system of claim 14, further comprising at least one connector extending between the first tray body of the first tooth portion and the second tray body of the second tooth portion.

16. The indirect bonding tray system of claim 15, wherein the at least one connector is constructed of a different material than the first tooth portion and the second tooth portion.

17. An indirect bonding tray for use in positioning a plurality of orthodontic appliances, the indirect bonding tray comprising:
a tray body having an exterior surface and an occlusal surface generally opposed to the exterior surface, the occlusal surface configured to conform to occlusal surfaces of associated teeth of a patient's dentition; and
a plurality of apertures formed into the tray body, each aperture of the plurality of apertures located at a position in the tray body associated with a particular tooth of the patient's dentition;
wherein each aperture of the plurality of apertures is digitally designed and individually oriented to receive an arm carrying an orthodontic appliance such that movement of the arm within the aperture guides the orthodontic appliance to a predetermined placement of the orthodontic appliance on the particular tooth of the patient's dentition.

18. The indirect bonding tray of claim 17, wherein the tray body is formed of at least a first tray portion and a second tray portion, each of the first tray portion and the second tray portion comprising at least one of the plurality of apertures and the indirect bonding tray further comprises:
at least one connector extending between the first tray portion and the second tray portion and securing the first tray portion to the second tray portion.

19. The indirect bonding tray of claim 17, wherein the plurality of apertures comprises at least one hole and at least one trough.

20. The indirect bonding tray of claim 17, wherein the tray body further comprises at least one guide arm defining a notch, and the at least one guide arm and the notch are digitally designed and individually dimensioned to define a predetermined idealized placement of an orthodontic appliance on a particular tooth of the patient's dentition to which the at least one guide arm and the notch are associated.
